(19) United States
(12) Patent Application Publication
(10) Pub. No.: US 2023/0176547 A1
(43) Pub. Date: Jun. 8, 2023

(54) NUMERICAL CONTROLLER FOR CONTROLLING TAPPING ON BASIS OF PROCESSING PROGRAM

(71) Applicant: FANUC CORPORATION, Yamanashi (JP)

(72) Inventor: Nobuhito OONISHI, Yamanashi (JP)

(21) Appl. No.: 17/999,051

(22) PCT Filed: May 17, 2021
(86) PCT No.: PCT/JP2021/018529

§ 371 Date: Nov. 17, 2022

(30) Foreign Application Priority Data
May 19, 2020 (JP) 2020-087381

(51) Int. Cl. G05B 19/4155

(52) U.S. Cl. CPC G05B 19/4155; G05B 2219/45203

(57) ABSTRACT

A command analysis unit in a numerical controller analyzes a fixed cycle command in a processing program and outputs the analysis result to a fixed cycle calculation unit. The unit generates a command data sequence including a plurality of command data based on the analysis result. The unit includes a surplus calculation unit calculating a surplus cutting depth based on an overall cutting depth and a cutting depth in each cut, the respective cutting depths being specified by the fixed cycle command and being applied to a workpiece by a tapping tool, and a command data sequence adjustment unit that adjusting the order or the cutting depth of the command data in the command data sequence based on the surplus cutting depth to reduce a total feed movement amount by which the tapping tool moves in accordance with the command data sequence.

### RELATED APPLICATIONS

The present application is a National Phase of International Application No. PCT/JP2021/018529 filed May 17, 2021, which claims priority to Japanese Application No. 2020-087381, filed May 19, 2020.

### TECHNICAL FIELD

The present invention relates to a numerical controller, and more particularly to a numerical controller for controlling tapping, in which a female screw is formed on an inner surface of a prepared hole formed in a workpiece in accordance with a fixed cycle, on the basis of a processing program.

### BACKGROUND ART

Tapping is known conventionally as processing for forming a female screw on the inner surface of a prepared hole formed in a workpiece. In tapping, processing is performed to cut a groove in the inner surface of the formed prepared hole, and therefore, if the rotation and cutting depth ranges of a tapping tool are not controlled appropriately, a problem occurs in that the load on the tapping tool becomes excessive such that the tapping tool is damaged.

To suppress this damage to the tapping tool, PTL 1, for example, discloses a tapping control device for a machine tool, in which a digital spindle motor controlled by a digital control circuit is used in a spindle motor. The tapping control device includes position control means that feedback-controls the position of the digital spindle motor on the basis of a feedback signal output from a pulse coder in accordance with the rotation of the digital spindle motor and outputs a speed command to the digital control circuit. Further, the tapping control device performs tapping control in accordance with a fixed cycle in which a reciprocating operation is performed repeatedly. In the reciprocating operation, a pulse is linearly interpolated by an interpolation circuit and distributed, in accordance with a pitch amount of a screw to be processed, to the digital control circuit of the digital spindle motor and a servo circuit of a servo motor for moving the tool in an axial direction, whereby the digital spindle motor and the servo motor are driven in synchronization with each other and rotated forward such that tapping is performed by a fixed amount, whereupon the digital spindle motor and the servo motor are rotated in reverse such that the tap is retracted by a smaller distance than the fixed amount.

It is stated that according to this tapping control technique, chips are eliminated from the tapped hole and the resistance exerted on the tapping tool is reduced, making the tapping easier, and as a result, breakages of the tapping tool can be reduced.

### CITATION LIST

### Patent Literature

[PTL 1] Japanese Patent Application Laid-Open Publication No. S62-224520

### SUMMARY OF INVENTION

### Technical Problem

Not only in tapping but also in a case where a hole is formed in a workpiece by drilling performed in accordance with a fixed cycle, for example, when a cutting operation performed by a machining tool is divided into a plurality of operations in order to reduce the load exerted on the machining tool, the distance covered by the machining tool in a return operation increases in accordance with a combination of the number of cuts and the cutting depth, and as a result, the overall execution time of the processing may increase. In other words, when the cutting depth per operation is increased, the return stroke following the processing naturally increases, leading to an increase in the return time of the machining tool. Particularly in a case where it is necessary to synchronize rotation and movement of the tapping tool also during the return operation of the tapping tool, such as during tapping, this problem of an increase in the overall processing time becomes more prominent.

Hence, there is demand for a numerical controller that can suppress an increase in processing time during tapping control performed in accordance with a fixed cycle.

### Solution to Problem

In the present invention, the problem described above is solved by providing a numerical controller with a function for reducing the total feed movement amount of a tapping tool during tapping control performed in accordance with a fixed cycle by adjusting the execution order or the cutting depth of the steps of the tapping control, and as a result shortening the overall execution time of the fixed cycle.

An aspect of the numerical controller according to the present invention controls tapping, in which a female screw is formed on an inner surface of a prepared hole formed in a workpiece in accordance with a fixed cycle, on the basis of a processing program, the numerical controller including a fixed cycle calculation unit that analyzes a fixed cycle command included in the processing program and generates a command data sequence including a plurality of command data on the basis of the analysis result, wherein the fixed cycle calculation unit includes a surplus calculation unit that calculates a surplus cutting depth on the basis of an overall cutting depth applied to the workpiece by a tapping tool and a cutting depth applied to the workpiece by the tapping tool in each cut, the respective cutting depths being specified by the fixed cycle command, and a command data sequence adjustment unit that adjusts the order or the cutting depth of the command data included in the command data sequence on the basis of the surplus cutting depth so as to reduce a total feed movement amount by which the tapping tool moves in accordance with the command data sequence.

The command data sequence adjustment unit may further include an order modification unit that modifies the order of the command data included in the command data sequence so that command data specifying a cutting feed operation of the surplus cutting depth are executed first.

The command data sequence adjustment unit may further include a surplus redistribution unit which, when the surplus cutting depth does not exceed a preset cutting threshold, distributes the surplus cutting depth to command data specifying a cutting feed operation of the cutting depth that is applied to the workpiece by the tapping tool in each cut, the cutting depth being specified by the fixed cycle command.

The command data sequence adjustment unit may further include a surplus redistribution unit that measures a load torque of a spindle motor to which the tapping tool is attached during execution of the final command data of the command data sequence, and adds the surplus cutting depth to the cutting depth of the final command data within a range where the load torque does not exceed a preset torque threshold.

### Advantageous Effects of Invention

According to the present invention, the movement distance of a return operation of the tapping tool can be shortened in comparison with a conventional operation without the need for the operator to consciously modify the cutting depth. As a result, the execution time required for the tapping control can be shortened. Moreover, when possible, the surplus step is redistributed, and therefore the number of cuts performed in the fixed cycle can be reduced in comparison with a conventional operation, enabling a further reduction in the execution time.

### BRIEF DESCRIPTION OF DRAWINGS

FIG. 1A is a view illustrating a method for adjusting the execution order of the steps of a fixed cycle controlled by a numerical controller (in which a surplus step is executed as the final step).

FIG. 1B is a view illustrating a method for adjusting the execution order of the steps of a fixed cycle controlled by a numerical controller according to the present invention (in which the surplus step is executed as the first step).

FIG. 2A is a view showing a cutting operation performed in response to an identical tapping cycle command as that of FIG. 1A.

FIG. 2B is a view illustrating a case in which the cutting depth of each step of the tapping control performed by the numerical controller of the present invention is increased relative to FIG. 2A.

FIG. 3A is a view showing a cutting operation performed in response to an identical tapping cycle command to that of FIG. 1A in a case where the surplus step is executed as the final step.

FIG. 3B is a view showing a cutting operation performed in a case where a cutting depth q′ of the surplus step is distributed to a normal cutting depth q.

FIG. 4A is a view showing a cutting operation performed in response to an identical tapping cycle command to that of FIG. 1A in a case where the surplus step is executed as the final step.

FIG. 4B is a view showing a cutting operation performed in a case where the cutting depth q′ of the surplus step is added to the normal cutting depth q of a final block.

FIG. 5 is a view showing the configuration of main parts of a numerical controller according to an embodiment of the present invention.

FIG. 6 is a schematic view showing functions of the numerical controller according to this embodiment of the present invention.

FIG. 7 is a schematic flowchart showing operations performed in a case where the execution order of the steps of the fixed cycle is adjusted.

FIG. 8 is a schematic flowchart showing operations performed in a case where the cutting depths of the steps of the fixed cycle are adjusted (equally distributed) using a cutting threshold.

FIG. 9A is a schematic flowchart (1) showing operations performed in a case where the cutting depths of the steps of the fixed cycle are adjusted using a torque threshold of a spindle motor.

FIG. 9B is a schematic flowchart (2) showing operations performed in a case where the cutting depths of the steps of the fixed cycle are adjusted using the torque threshold of the spindle motor.

### DESCRIPTION OF EMBODIMENTS

Embodiments of the present invention will be described below together with the drawings.

A numerical controller of the present invention, when executing a fixed cycle command during tapping control for forming a female screw on the inner surface of a prepared hole formed in a workpiece in accordance with a fixed cycle, adjusts the execution order or the cutting depth of the steps of the fixed cycle so as to minimize the movement amount of a tapping tool, and as a result shortens the execution time of the fixed cycle.

Note that the operation for “forming a female screw on the inner surface of a prepared hole formed in a workpiece” includes a case in which a prepared hole of a predetermined depth is formed in the workpiece in advance, whereupon the female screw is formed on the inner surface of the prepared hole using a tapping tool, a case in which the prepared hole is formed by drilling and the screw is cut by tapping simultaneously in a single cut using a drill tapping tool on which a drill for forming holes and a tap for cutting screws are formed integrally, and so on.

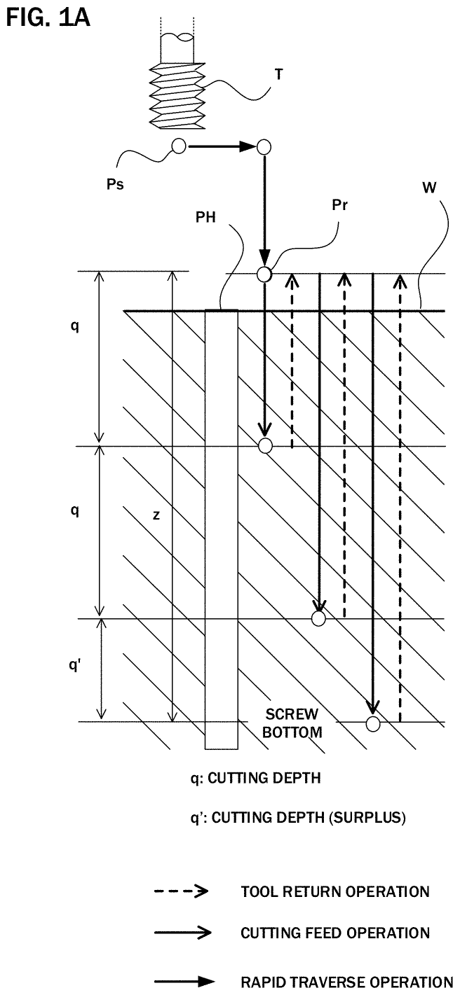

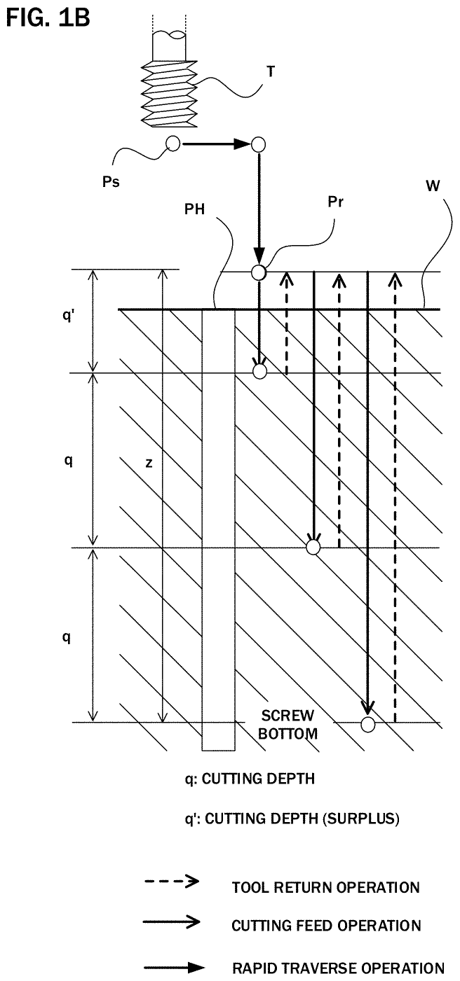

A method for adjusting the execution order of the steps of a fixed cycle executed by the numerical controller of the present invention will now be described using FIGS. 1A, 1B, 2A, 2B, 3A, 3B, 4A, and 4B.

Note that FIGS. 1A to 4B show examples of a case in which, at the time of the tapping control, a prepared hole PH of a predetermined depth has been formed in advance in a workpiece W so that a female screw of a screw depth z is formed on the inner surface of the prepared hole PH by cutting the inner surface using a tapping tool T that rotates coaxially with the prepared hole PH.

Further, during tapping, a rotation motor for rotating the tapping tool T and a feed motor for feeding the tapping tool T are synchronously controlled. In an example of the tapping, the tapping tool T is rotated forward during cutting feed operations for forming the female screw and rotated in reverse during tool return operations for returning the tapping tool T to a return point Pr.

### First Embodiment

FIG. 1A shows a cutting operation performed by the tapping tool in response to a tapping cycle command in a case where the cutting depth is set as q (the cutting depth of a surplus step is set as q′) and the surplus step is implemented as the final step. In the tapping processing cycle shown in FIG. 1A, the following operations are performed.

Operation 1: The tapping tool T is fed rapid traverse from a start point Ps to the return point Pr.
Operation 2: The tapping tool T is fed at a constant cutting speed from the return point Pr by the cutting depth q while being rotated forward.
Operation 3: In order to temporarily release the load on the tapping tool T, the tapping tool T is returned to the return point Pr at the same speed as during the cutting operation while being rotated in reverse.
Operation 4: The tapping tool T is fed from the return point Pr at a constant cutting speed while being rotated forward by a cutting depth 2q, which is acquired by further adding the cutting depth q to the previous cutting depth.
Operation 5: The tapping tool T is returned to the return point Pr at the same speed as during the cutting operation while being rotated in reverse.
Operation 6: The tapping tool T is fed from the return point Pr at a constant cutting speed by a cutting depth 2q+q′ while being rotated forward.
Operation 7: The tapping tool T is returned to the return point Pr at the same speed as during the cutting operation while being rotated in reverse.
Operation 8: The tapping tool T is moved from the return point Pr to a start point of the next processing operation or to the tool origin.

FIG. 1B, meanwhile, shows a representative example executed by the numerical controller of the present invention, in which the execution order is modified so that the surplus step is executed first without changing the cutting depth from that of FIG. 1A. In the tapping processing cycle according to this representative example of the present invention, the following operations are performed.

Operation 1: The tapping tool T is fed rapid traverse from the start point Ps to the return point Pr.
Operation 2: The tapping tool T is fed at a constant cutting speed from the return point Pr by the cutting depth q′ while being rotated forward.
Operation 3: In order to temporarily release the load on the tapping tool T, the tapping tool T is returned to the return point Pr at the same speed as during the cutting operation while being rotated in reverse.
Operation 4: The tapping tool T is fed from the return point Pr at a constant cutting speed while being rotated forward by a cutting depth q′+q, which is acquired by further adding the cutting depth q to the previous cutting depth.
Operation 5: The tapping tool T is returned to the return point Pr at the same speed as during the cutting operation while being rotated in reverse.
Operation 6: The tapping tool T is fed from the return point Pr at a constant cutting speed by a cutting depth q′+2q while being rotated forward.
Operation 7: The tapping tool T is returned to the return point Pr at the same speed as during the cutting operation while being rotated in reverse.
Operation 8: The tapping tool T is moved from the return point Pr to the start point of the next processing operation or to the tool origin.

Here, to compare the overall movement amounts of the tapping tool T in the cases of FIGS. 1A and 1B, in the case of FIG. 1A,

(overall movement amount)=2×{q+2q+(2q+q′)}=10q+2q′.

In the case of FIG. 1B, meanwhile,

(overall movement amount)=2×{q′+(q′+q)+(q′+2q)}=6q+6q′.

At this time, the movement amount q′ is the movement amount of the surplus step, and therefore q>q′. Accordingly, the overall movement amount shown in FIG. 1B is smaller than the overall movement amount shown in FIG. 1A.

More specifically, in the tapping processing cycle, as long as the surplus step is at least not executed as the final step corresponding to the depth of the prepared hole PH, the movement amount q′ of the surplus step is executed a plurality of times, and therefore the overall movement amount can be reduced in comparison with a case where the surplus step is executed last.

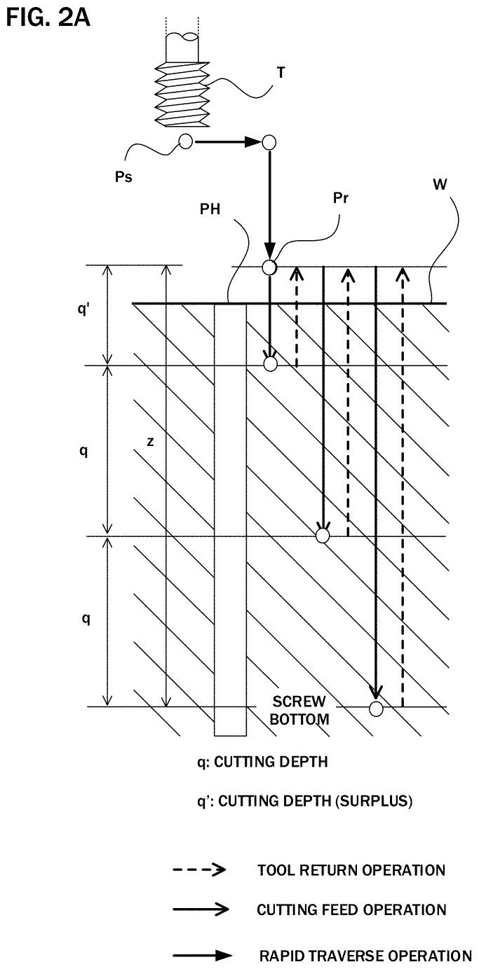

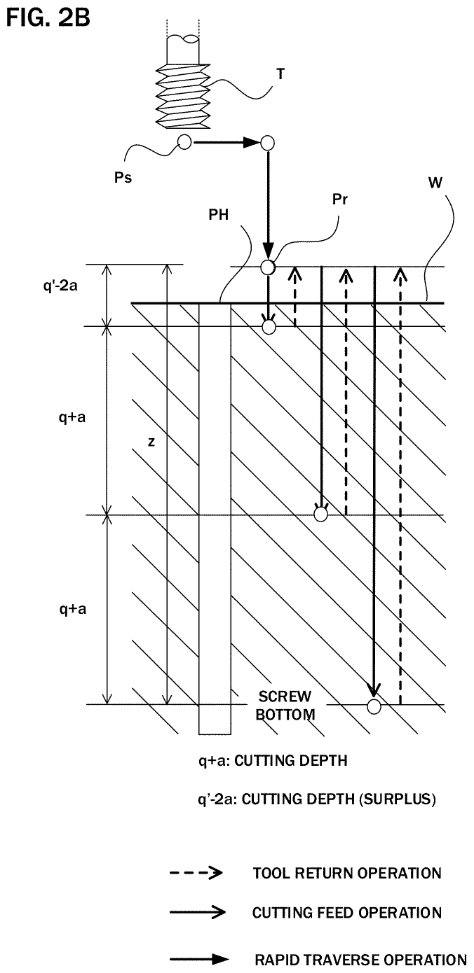

FIGS. 2A and 2B are views illustrating a modified example in which the cutting depth of each step is increased during the tapping control performed by the numerical controller of the present invention.

FIG. 2A shows a cutting operation performed in response to an identical tapping cycle command to that of FIG. 1B. Further, FIG. 2B shows a cutting operation performed in a case where the cutting depth of a single cut is increased by a relative to FIG. 2A. Note that a≤q′/2.

The overall movement amounts of the tapping tool T in the cases of FIGS. 2A and 2B will now be compared. The overall movement amount of the case shown in FIG. 2A is 6q+6q′, similarly to the case of FIG. 1B. However, the overall movement amount of the case shown in FIG. 2B is

(overall movement amount)=2×{(q′−2a)+(q′−2a+q+a)+(q′−2a+q+a+q+a)}=6q+6(q′−a).

Here, the increase a in the cutting depth of a single cut is set to be smaller than the cutting depth q′ of the surplus step. Therefore, when the execution order of the steps of the fixed cycle is adjusted by the method described above so that the surplus step is executed first and the cutting depth of each cutting operation is increased by a, which is smaller than the cutting depth q′ of the surplus step, the overall movement amount decreases further. As a result, the execution time of the tapping can be shortened even further.

Note that during control performed in relation to processing steps including a plurality of tool return operations, as long as the surplus step is at least not executed last, the overall movement amount of the tapping tool is reduced in comparison with a case where the surplus step is executed last, and therefore the surplus step does not necessarily have to be executed first. However, the overall movement amount of the tapping tool can be shortened more by ensuring that the surplus step is executed as early in the sequence as possible, and therefore the surplus step is preferably executed at as early a stage as the situation allows.

### Second Embodiment

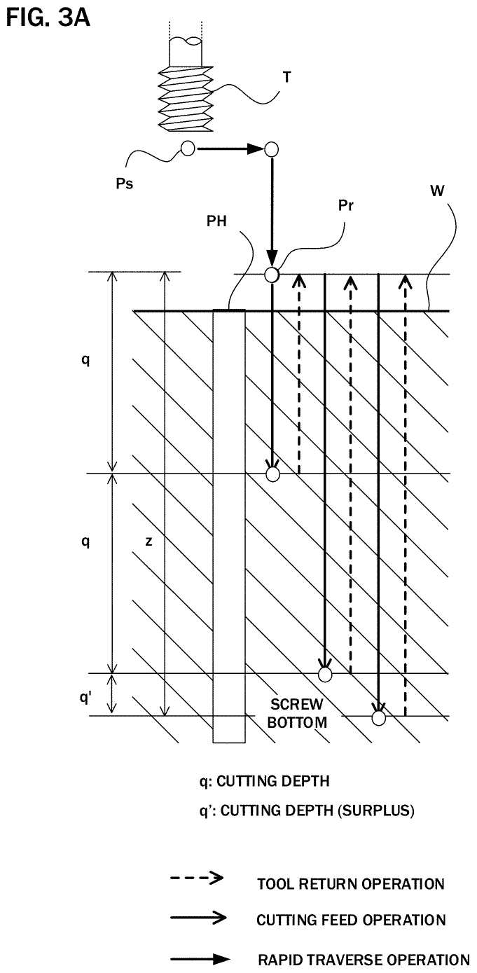

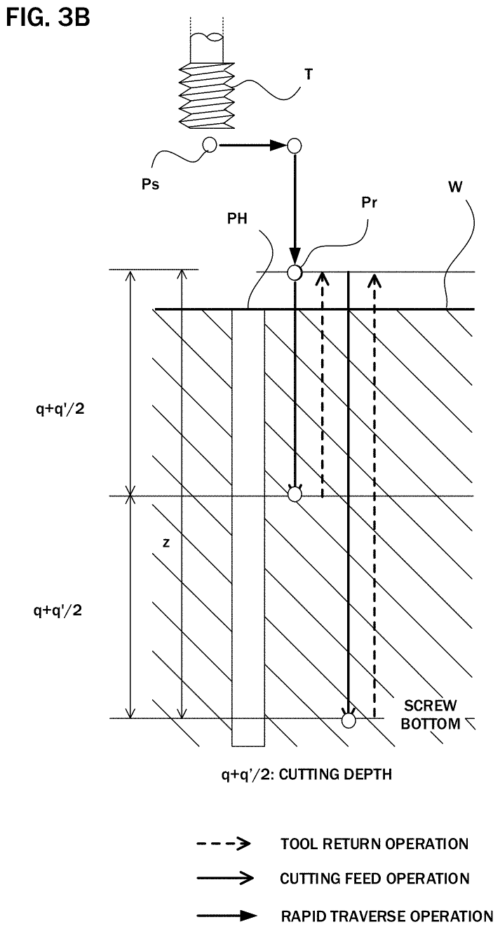

Next, a method for adjusting the cutting depth of the steps of the fixed cycle executed by the numerical controller of the present invention will be described using FIGS. 3A and 3B.

In a second embodiment, when the cutting depth q′ of the surplus step does not exceed a preset cutting threshold q1, the cutting depth q′ of the surplus step is distributed to command data specifying a cutting feed operation of the cutting depth that is applied to the workpiece W by the tapping tool T in each cut, this cutting depth being specified by the tapping cycle command.

FIG. 3A shows a cutting operation performed in response to an identical tapping cycle command to that of FIG. 1A in a case where the surplus step is executed as the final step, and FIG. 3B shows a cutting operation performed in a case where the cutting depth q′ of the surplus step is distributed to the cutting depth q of the normal cutting feed operation.

The overall movement amounts of the tapping tool T in the cases of FIGS. 3A and 3B will now be compared. The overall movement amount of the case shown in FIG. 3A is 10q+2q′, similarly to the case of FIG. 1A. In the case of FIG. 3B, however, since the original cutting depth q′ of the surplus step is distributed in portions of q′/2, assuming that the number of cuts is 2, the overall movement amount is

(overall movement amount)=2×{(q+q′/2)+2×(q+q′/2)}=6q+3q′.

Hence, by distributing the cutting depth q′ of the surplus step in accordance with the number of iterations of the cutting feed operation when the cutting depth q′ does not exceed the preset threshold q1, the number of iterations of the processing can be reduced, leading to a reduction in the overall movement amount, and as a result, the execution time can be shortened.

Note that the cutting depth of the surplus step does not necessarily have to be distributed equally between the other steps, and instead, the cutting depth of the surplus step may be added entirely to the final step or distributed in a smaller amount to the first step and a larger amount to the final step.

### Third Embodiment

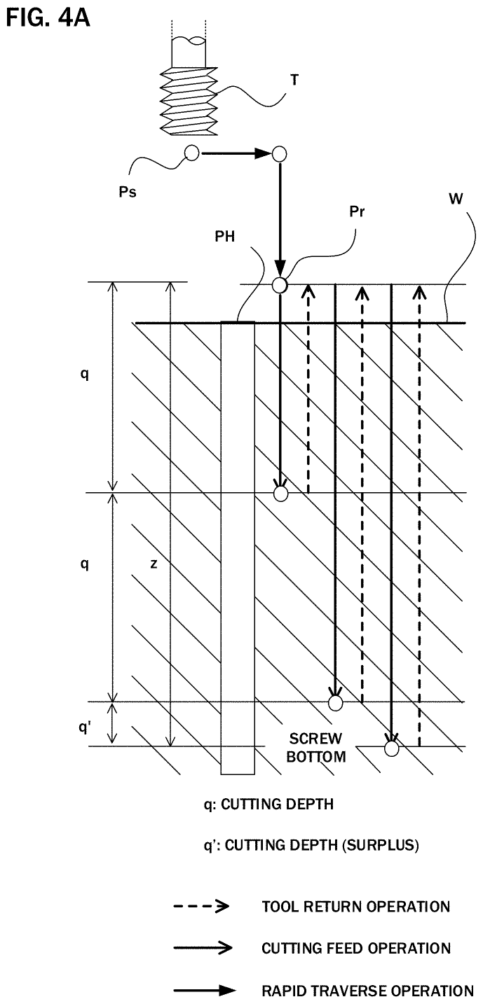

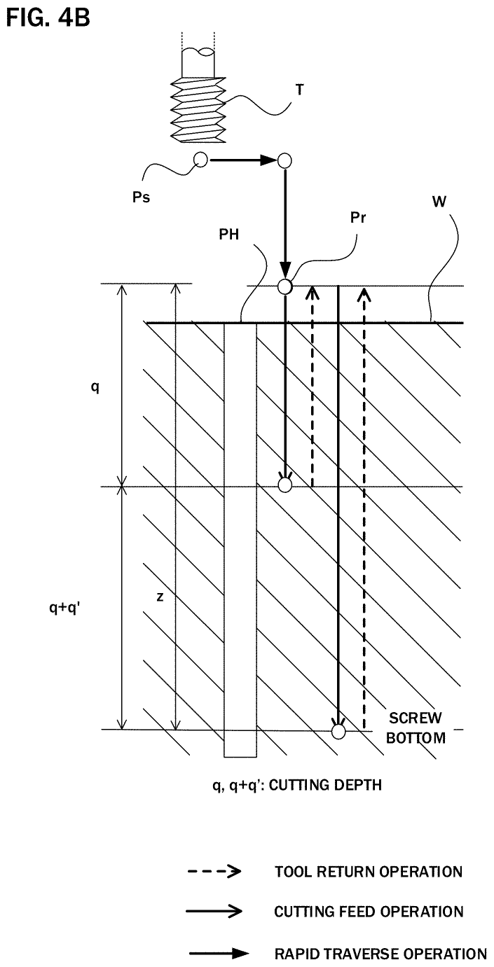

FIGS. 4A and 4B are views illustrating a method for adjusting the cutting depth of each step of a different fixed cycle to that described above.

In a third embodiment, when executing the final command data of a command data sequence specifying a sequence of cutting feed operations, the load torque of a spindle motor to which the tapping tool T is attached is measured, and the cutting depth q′ of the surplus step is added and distributed to the cutting depth of the final command data such that the load torque remains within a range not exceeding a preset torque threshold Tt.

FIG. 4A shows a cutting operation performed in response to an identical tapping cycle command to that of FIG. 1A in a case where the surplus step is executed as the final step. FIG. 4B shows a cutting operation performed in a case where the cutting depth q′ of the surplus step is added to the cutting depth q of the normal cutting feed operation of a final block.

Here, in the cutting operation shown in FIG. 4B, for example, when the load torque does not exceed the torque threshold Tt at the time of a second cutting operation serving as the final step, the cutting operation is continued, regardless of the cutting depth.

Hence, as long as the surplus step is sufficiently small, the load torque does not exceed the torque threshold Tt before reaching the bottom of the hole, and therefore, as shown in FIG. 4B, the female screw can be formed to the bottom of the hole by the second cutting operation.

At this time, comparing the overall movement amounts of the tapping tool T in the cases of FIGS. 4A and 4B, the overall movement amount of the case shown in FIG. 4A is 10q+2q′, similarly to the case of FIG. 1A. In the case of FIG. 4B, however, since the original cutting depth q′ of the surplus step is added and distributed to the second cutting operation serving as the final step, the overall movement amount is

(overall movement amount)=2×{q+(2q+q′)}=6q+2q′.

Hence, by adding and distributing the cutting depth q′ of the surplus step to the cutting feed operation of the final step when the load torque during implementation of the final step of the processing cycle does not exceed the predetermined torque threshold Tt, the overall movement amount of the processing steps can be reduced, and as a result, the execution time can be shortened.

A configuration of a numerical controller installed with the method for adjusting the execution order of the steps of the fixed tapping cycle described above or the method for adjusting the cutting depth of each step thereof will be described below.

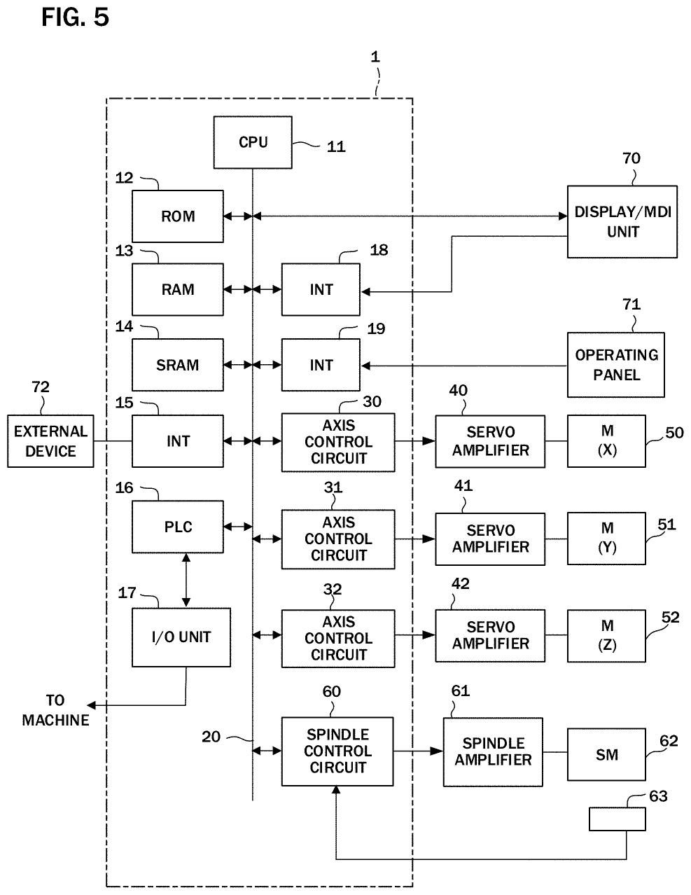

FIG. 5 is a hardware diagram showing the configuration of main parts of a numerical controller according to an embodiment of the present invention. A CPU 11 provided in a numerical controller 1 is a processor for performing overall control of the numerical controller 1.

The CPU 11 reads a system program stored in a ROM 12 via a bus 20 and performs overall control of the numerical controller 1 in accordance with the system program. A RAM 13 stores temporary calculation data and display data, various data input by an operator through a display/MDI unit 70, and so on.

An SRAM 14 is constituted by a nonvolatile memory that is backed up by a battery, not shown in the figure, so that the storage state thereof is maintained even after a power supply of the numerical controller 1 is switched off. The SRAM 14 stores a processing program to be described below, which is read via an interface 15, a processing program input through the display/MDI unit 70, and so on.

Further, various system programs for executing processing of an editing mode, which is required to create and edit the processing programs, and processing for adjusting the steps of the fixed cycle described above are written to the ROM 12 in advance.

The various processing programs, such as the processing programs for executing the present invention, can be input through the interface 15 and the display/MDI unit 70 and stored in the SRAM 14.

The interface 15 is an interface for connecting the numerical controller 1 to an external device 72 such as an adapter. The processing programs, various parameters, and so on are read from the external device 72 side.

Further, processing programs edited in the numerical controller 1 can be stored in external storage means via the external device 72. A PLC (Programmable Logic Controller) 16 controls an auxiliary device (for example, an actuator such as a robot hand for replacing a tapping tool) of a machine tool by outputting signals to the auxiliary device through an I/O unit 17 in accordance with a sequence program installed in the numerical controller 1.

Furthermore, the PLC 16 receives signals from various switches and the like on an operating panel disposed on the main body of the machine tool, performs required signal processing, and transfers the processed signals to the CPU 11.

The display/MDI unit 70 is a manual data input device including a display, a keyboard, and so on, and an interface 18 receives commands and data from the keyboard of the display/MDI unit 70 and transfers the received commands and data to the CPU 11. An interface 19 is connected to an operating panel 71 including a manual pulse generator and so on.

Axis control circuits 30 to 32 of respective axes receive movement command amounts for the respective axes from the CPU 11 and output commands for the respective axes to servo amplifiers 40 to 42. Upon reception of the commands, the servo amplifiers 40 to 42 drive servo motors 50 to 52 of the respective axes.

The servo motors 50 to 52 of the respective axes each have an inbuilt position/speed detector, and the servo motors 50 to 52 perform position/speed feedback control by respectively feeding position/speed feedback signals from the position/speed detectors back to the axis control circuits 30 to 32. Note that the position/speed feedback is not shown on the block diagram.

A spindle control circuit 60 receives a spindle rotation command for the machine tool and outputs a spindle speed signal to a spindle amplifier 61. Upon reception of the spindle speed signal, the spindle amplifier 61 rotates a spindle motor 62 of the machine tool at the rotation speed specified in the command so as to drive a tapping tool.

A position coder 63 is joined to the spindle motor 62 by a gear, a belt, or the like, and the position coder 63 outputs a feedback pulse in synchronization with the rotation of a spindle, whereupon the feedback pulse is read by the CPU 11.

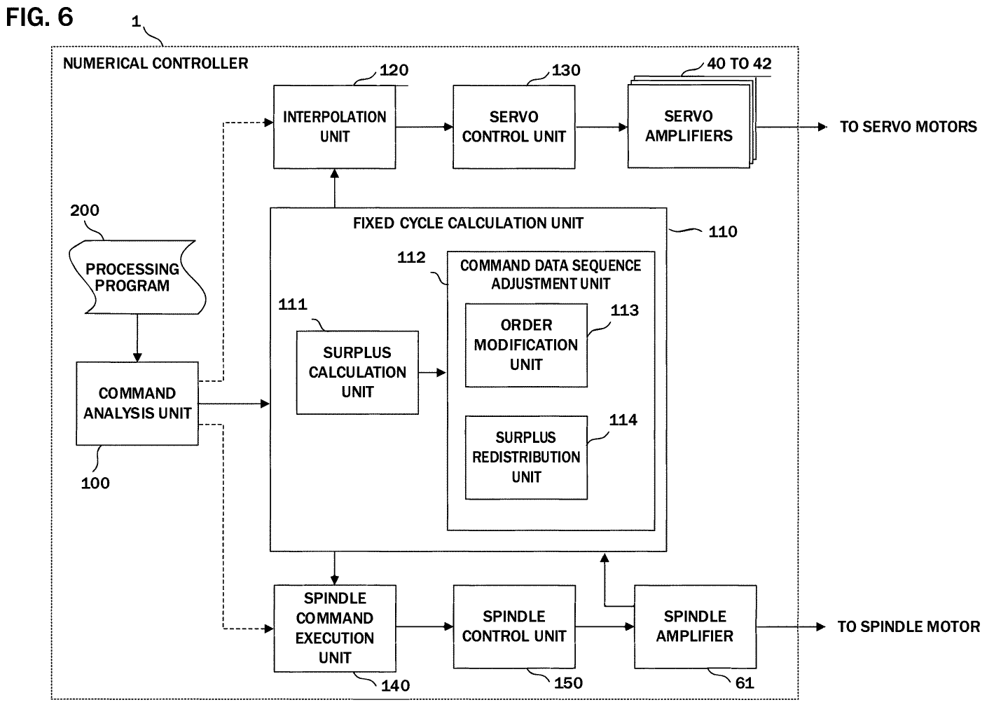

FIG. 6 is a schematic function block diagram showing a case in which the method for adjusting the execution order of the steps of the fixed tapping cycle described above or the method for adjusting the cutting depth of each step thereof is installed in the numerical controller 1 shown in FIG. 5 as a system program.

The numerical controller 1 includes a command analysis unit 100, a fixed cycle calculation unit 110, an interpolation unit 120, a servo control unit 130, a spindle command execution unit 140, and a spindle control unit 150.

Moreover, the fixed cycle calculation unit 110 further includes a surplus calculation unit 111 and a command data sequence adjustment unit 112 including at least one of an order modification unit 113 and a surplus redistribution unit 114.

The command analysis unit 100 reads and analyzes blocks in succession from a divided processing program 200 stored in a memory. When an analyzed block is a command block specifying normal movement, the command analysis unit 100 creates command data specifying movement of the respective axes on the basis of the analysis result, and outputs the created command data to the interpolation unit 120 (a dotted line arrow in FIG. 6).

Further, when the analyzed block is a command block specifying rotation of the spindle motor 62, the command analysis unit 100 creates spindle command data for commanding the spindle motor 62 on the basis of the analysis result, and outputs the created spindle command data to the spindle command execution unit 140 (a dotted line arrow in FIG. 6).

At this time, the command analysis unit 100 has a function for performing control so as to synchronize the commands issued to the servo motors 50 to 52 of the respective axes and the spindle motor 62 during the tapping so that forward rotation and reverse rotation are realized by identical rotation and movement operations during both the cutting feed operations and the tool return operations.

Furthermore, when the analyzed block is a command block specifying the fixed cycle, the command analysis unit 100 outputs the analysis result to the fixed cycle calculation unit 110.

The fixed cycle calculation unit 110 successively generates command data specifying the route of the tapping tool T on the basis of an analysis result indicating the fixed cycle command, received from the command analysis unit 100, and generates a command data sequence constituted by the series of cutting feed operations, tool return operations, and so on shown in FIGS. 1A to 4B, for example, on the basis of respective command values indicated by the fixed cycle command.

When generating the command data sequence at this time, the fixed cycle calculation unit 110 calculates the cutting depth q′ of the surplus step using the surplus calculation unit 111, whereupon the command data sequence adjustment unit 112 adjusts the command data sequence by executing the method for adjusting the steps of the fixed cycle, described above using FIGS. 1A to 4B, on the basis of the calculated cutting depth q′ of the surplus step.

The command data sequence adjustment unit 112 includes at least one of the order modification unit 113 that executes the method for adjusting the execution order of the steps, illustrated in FIGS. 1A, 1B, 2A, and 2B, and the surplus redistribution unit 114 that executes the method for adjusting the cutting depth of each step, illustrated in FIGS. 3A, 3B, 4A, and 4B, and adjusts the command data sequence by executing the adjustment method that is applicable to the fixed cycle command analyzed by the command analysis unit 100.

When a plurality of adjustment methods can be executed, the command data sequence adjustment unit 112 selects the adjustment method with which the execution time of the fixed cycle can be shortened to the greatest degree from the respective adjustment methods.

The interpolation unit 120 generates interpolation data on the basis of the command data output by the command analysis unit 100 or the command data sequence output by the fixed cycle calculation unit 110 by interpolating points on the command route specified by the command data (sequence) at interpolation intervals, performs acceleration/deceleration processing on the interpolation data to adjust the speeds of the respective drive axes at each interpolation interval, and outputs the interpolation data subjected to acceleration/deceleration adjustment to the servo control unit 130.

More specifically, during the tapping, the movement speeds during forward rotation corresponding to the cutting feed operation and reverse rotation corresponding to the tool return operation are controlled so as to be synchronized with the rotation speed of the tapping tool T at an identical ratio.

The servo control unit 130 controls the drive units (the servo motors 50 to 52) of the respective axes of the control subject machine via the servo amplifiers 40 to 42 on the basis of the output of the interpolation unit 120.

The spindle command execution unit 140 generates data relating to rotation (forward rotation and reverse rotation) and stoppage of the spindle motor, which are specified by the spindle command data (sequence), on the basis of the spindle command data output by the command analysis unit 100 or the spindle command data sequence output by the fixed cycle calculation unit 110, and outputs the generated data to the spindle control unit 150.

The spindle control unit 150 controls the spindle motor 62 of the control subject machine via the spindle amplifier 61 on the basis of the output of the spindle command execution unit 140.

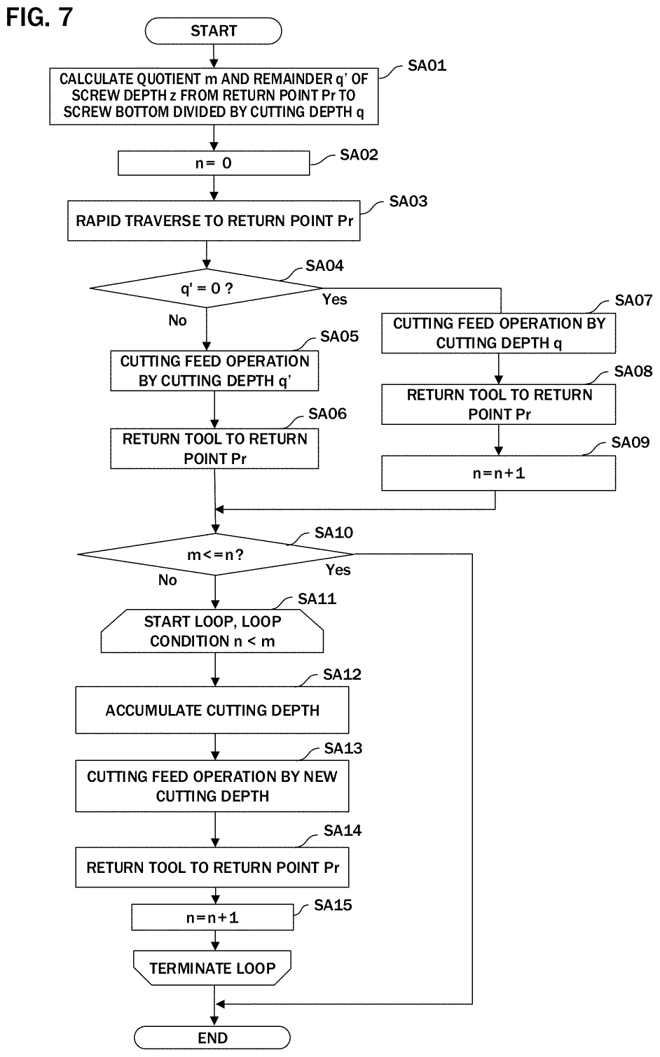

FIG. 7 is a schematic flowchart showing a flow of operations of the fixed cycle calculation unit 110 in a case where the execution order of the steps of the fixed tapping cycle is adjusted by the order modification unit 113. Note that FIG. 7 also shows a case in which the prepared hole PH has been formed in the workpiece W in advance.

[Step SA01] The surplus calculation unit 111 calculates the quotient (the number of iterations) m and the remainder q′ of the screw depth z from the return point Pr specified by the block of the fixed cycle to the screw bottom divided by the cutting depth q, and temporarily stores the calculated values in the memory.

[Step SA02] An initial value of the number of cuts n corresponding to the cutting depth q is set at 0.

[Step SA03] The order modification unit 113 commands the fixed cycle calculation unit 110 to first of all output command data for feeding the tapping tool T rapid traverse from the start point Ps to a processing position (the return point Pr). The fixed cycle calculation unit 110 outputs command data in accordance with the command of the order modification unit 113.

[Step SA04] The order modification unit 113 determines whether the cutting depth q′ of the surplus step is 0 (i.e., whether q′=0). When q′ is 0, the processing is advanced to step SA07, and when q′ is not 0, the processing is advanced to step SA05.

[Step SA05] The order modification unit 113 commands the fixed cycle calculation unit 110 to output command data for performing a cutting feed operation in which the workpiece W is cut by the cutting depth q′ while rotating the tapping tool T forward. The fixed cycle calculation unit 110 outputs command data in accordance with the command of the order modification unit 113.

[Step SA06] The order modification unit 113 commands the fixed cycle calculation unit 110 to output command data for returning the tapping tool T to the return point Pr while rotating the tapping tool T in reverse. The fixed cycle calculation unit 110 outputs command data in accordance with the command of the order modification unit 113.

[Step SA07] The order modification unit 113 commands the fixed cycle calculation unit 110 to output command data for performing a cutting feed operation in which the workpiece W is cut by the cutting depth q while rotating the tapping tool T forward. The fixed cycle calculation unit 110 outputs command data in accordance with the command of the order modification unit 113.

[Step SA08] The order modification unit 113 commands the fixed cycle calculation unit 110 to output command data for returning the tapping tool T to the return point Pr while rotating the tapping tool T in reverse. The fixed cycle calculation unit 110 outputs command data in accordance with the command of the order modification unit 113.

[Step SA09] The order modification unit 113 adds 1 to the value of n.

[Step SA10] The order modification unit 113 determines whether the value of m stored in the memory is equal to or smaller than n (i.e., whether m≤n). When m is equal to or smaller than n, the current processing is terminated, and when m is not equal to or smaller than n, the processing is advanced to step SA11.

[Step SA11] The order modification unit 113 executes step SA11 to step SA13 repeatedly until n reaches m stored in the memory (i.e., until n=m).

[Step SA12] The order modification unit 113 further adds q to the cutting depth at the time of the previous cutting feed operation and sets the result as the new cutting depth.

[Step SA13] The order modification unit 113 commands the fixed cycle calculation unit 110 to output command data for performing a cutting feed operation in which the workpiece W is cut by the new cutting depth while rotating the tapping tool T forward. The fixed cycle calculation unit 110 outputs command data in accordance with the command of the order modification unit 113.

[Step SA14] The order modification unit 113 commands the fixed cycle calculation unit 110 to output command data for returning the tapping tool T to the return point Pr while rotating the tapping tool T in reverse. The fixed cycle calculation unit 110 outputs command data in accordance with the command of the order modification unit 113.

[Step SA15] A value acquired by adding 1 to n is set as n.

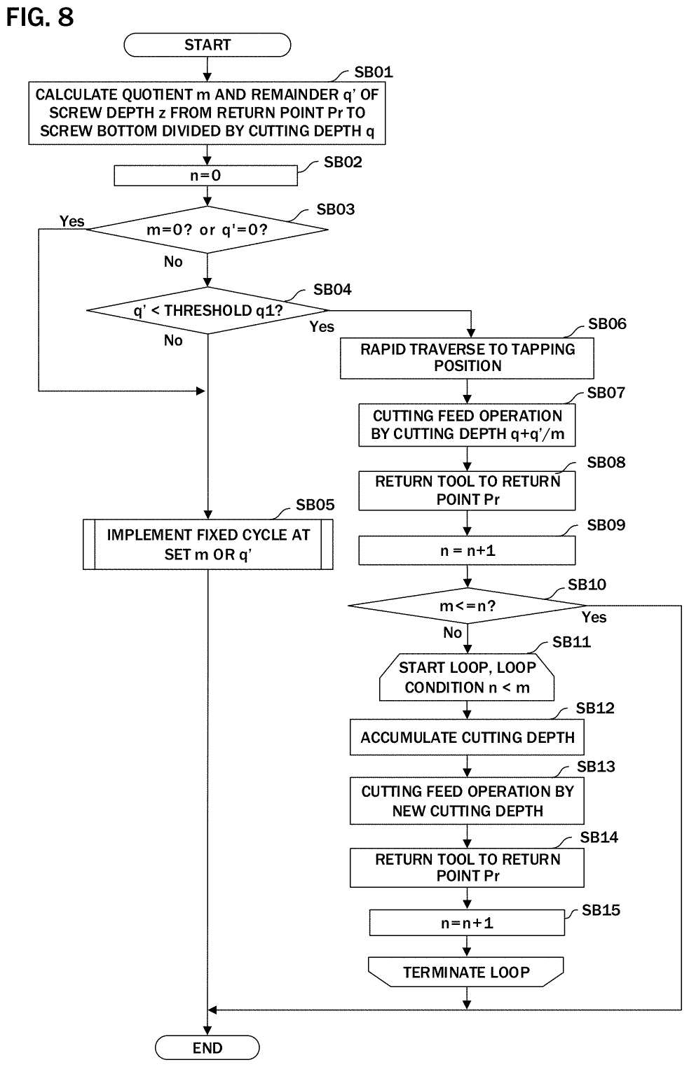

FIG. 8 is a schematic flowchart showing a flow of operations of the fixed cycle calculation unit 110 in a case where the cutting depths of the steps of the fixed tapping cycle are adjusted (equally distributed) by the surplus redistribution unit 114 using the cutting depth threshold q1. Note that similarly to the case shown in FIG. 7, FIG. 8 shows a case in which the prepared hole PH has been formed in the workpiece W in advance.

[Step SB01] The surplus calculation unit 111 calculates the quotient (the number of iterations) m and the remainder q′ of the screw depth z from the return point Pr specified by the block of the fixed cycle to the screw bottom divided by the cutting depth q, and temporarily stores the calculated values in the memory.

[Step SB02] The initial value of the number of cuts n corresponding to the cutting depth q is set at 0.

[Step SB03] The surplus redistribution unit 114 determines whether either of the quotient m and the cutting depth q′ of the surplus step, calculated in step SB01, is 0 (i.e., whether m=0 or q′=0). When either of these values is 0, the processing is advanced to step SB05, and when neither is 0, the processing is advanced to step SB04.

[Step SB04] The surplus redistribution unit 114 determines whether the cutting depth q′ of the surplus step, calculated in step SB01, is smaller than the preset cutting threshold q1. When the cutting depth q′ is smaller than the cutting threshold q1, the processing is advanced to step SB06, and when the cutting depth q′ is equal to or larger than the cutting threshold q1, the processing is advanced to step SB05.

[Step SB05] The surplus redistribution unit 114 commands the fixed cycle calculation unit 110 to generate and output a command data sequence of a fixed cycle based on the quotient m or the remainder q′ set in step SB01, whereupon the current processing is terminated. More specifically, when m=0, a cutting feed operation for making a cut corresponding to the remainder q′ is executed, and when q′=0, a cutting feed operation is executed repeatedly n times while accumulating the cutting depth q for each cut. Note that when the cutting depth q′ is equal to or larger than q1 (i.e., when q′≥q1) in step SB04, a similar operation to that of the flow shown in FIG. 7 is executed in step SB05.

[Step SB06] The surplus redistribution unit 114 commands the fixed cycle calculation unit 110 to first of all output command data for feeding the tapping tool T rapid traverse from the start point Ps to the processing position (the return point Pr). The fixed cycle calculation unit 110 outputs command data in accordance with the command of the surplus redistribution unit 114.

[Step SB07] The surplus redistribution unit 114 commands the fixed cycle calculation unit 110 to output command data for performing a cutting feed operation in which the workpiece is cut by a cutting depth of q+q′/m while rotating the tapping tool T forward. The fixed cycle calculation unit 110 outputs command data in accordance with the command of the surplus redistribution unit 114.

[Step SB08] The surplus redistribution unit 114 commands the fixed cycle calculation unit 110 to output command data for returning the tapping tool T to the return point Pr while rotating the tapping tool T in reverse. The fixed cycle calculation unit 110 outputs command data in accordance with the command of the surplus redistribution unit 114.

[Step SB09] The surplus redistribution unit 114 adds 1 to the value of n.

[Step SB10] The surplus redistribution unit 114 determines whether the value of m stored in the memory is equal to or smaller than n (i.e., whether m≤n). When m is equal to or smaller than n, the current processing is terminated, and when m is not equal to or smaller than n, the processing is advanced to step SB11.

[Step SB11] The surplus redistribution unit 114 executes step SB12 to step SB14 repeatedly until n reaches m stored in the memory (i.e., until n=m).

[Step SB12] The surplus redistribution unit 114 further adds q+q′/m to the cutting depth at the time of the previous cutting feed operation and sets the result as the new cutting depth.

[Step SB13] The surplus redistribution unit 114 commands the fixed cycle calculation unit 110 to output command data for performing a cutting feed operation in which the workpiece is cut by the new cutting depth while rotating the tapping tool T forward. The fixed cycle calculation unit 110 outputs command data in accordance with the command of the surplus redistribution unit 114.

[Step SB14] The surplus redistribution unit 114 commands the fixed cycle calculation unit 110 to output command data for returning the tapping tool T to the return point Pr while rotating the tapping tool T in reverse. The fixed cycle calculation unit 110 outputs command data in accordance with the command of the surplus redistribution unit 114.

[Step SB15] A value acquired by adding 1 to n is set as n.

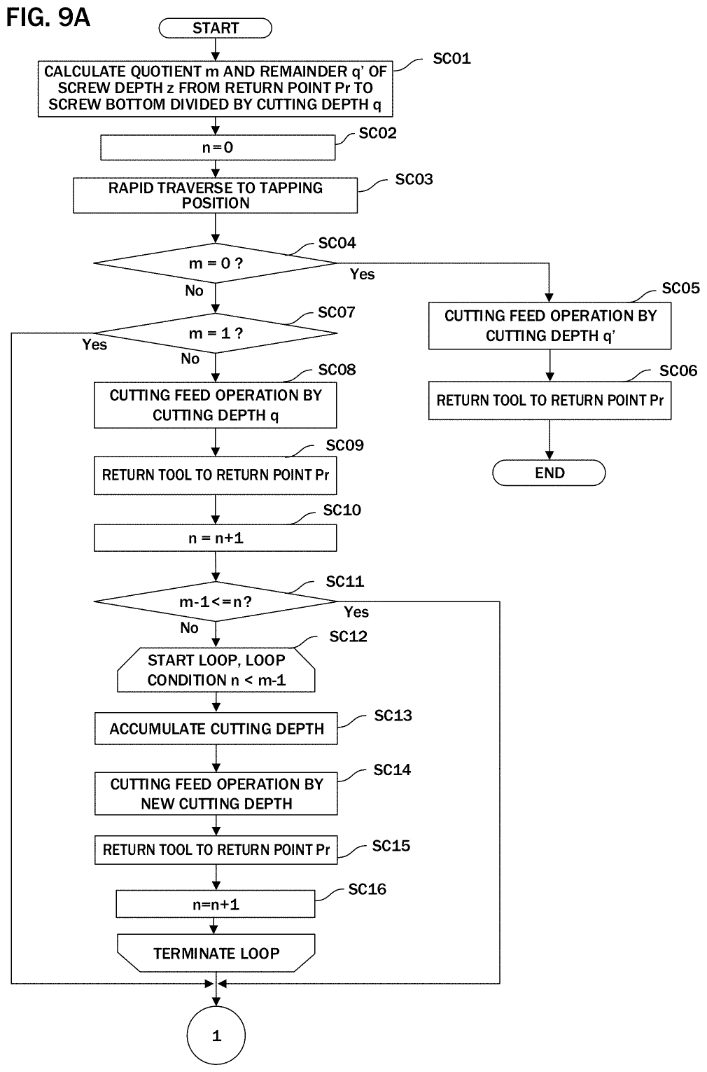

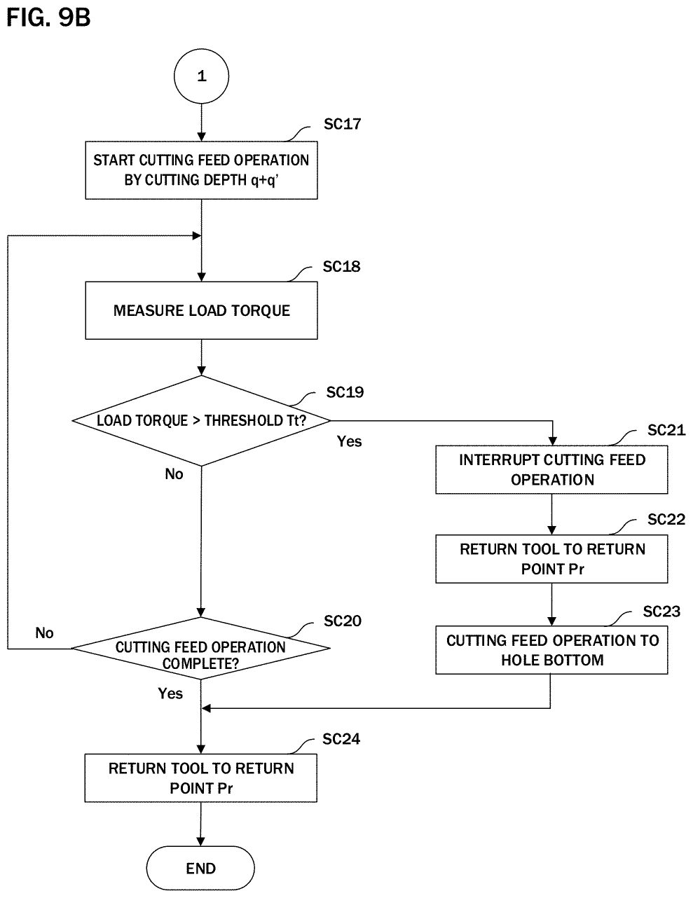

FIGS. 9A and 9B are schematic flowchart showing a flow of operations of the fixed cycle calculation unit 110 in a case where the cutting depths of the steps of the fixed tapping cycle are adjusted by the surplus redistribution unit 114 using the torque threshold Tt of the load torque of the spindle motor 62. Note that similarly to the case shown in FIG. 7, FIGS. 9A and 9B show a case in which the prepared hole PH has been formed in the workpiece W in advance.

First, on the flowchart shown in FIG. 9A, operations are executed up to a point immediately before the surplus redistribution unit 114 distributes the surplus (i.e., up to a number of iterations m−1 one before the number of iterations m).

[Step SC01] The surplus calculation unit 111 calculates the quotient (the number of iterations) m and the remainder q′ of the screw depth z from the return point Pr specified by the block of the fixed cycle to the screw bottom divided by the cutting depth q, and temporarily stores the calculated values in the memory.

[Step SC02] The initial value of the number of cuts n corresponding to the cutting depth q is set at 0.

[Step SC03] The surplus redistribution unit 114 commands the fixed cycle calculation unit 110 to first of all output command data for feeding the tapping tool T rapid traverse from the start point Ps to the processing position (the return point Pr). The fixed cycle calculation unit 110 outputs command data in accordance with the command of the surplus redistribution unit 114.

[Step SC04] The surplus redistribution unit 114 determines whether the value of m stored in the memory is 0 (i.e., whether m=0). When m is 0, the processing is advanced to step SC05, and when m is not 0, the processing is advanced to step SC07.

[Step SC05] The surplus redistribution unit 114 commands the fixed cycle calculation unit 110 to output command data for performing a cutting feed operation in which the workpiece is cut by the cutting depth q′ while rotating the tapping tool T forward. The fixed cycle calculation unit 110 outputs command data in accordance with the command of the surplus redistribution unit 114.

[Step SC06] The surplus redistribution unit 114 commands the fixed cycle calculation unit 110 to output command data for returning the tapping tool T to the return point Pr while rotating the tapping tool T in reverse, whereupon the current processing is terminated. The fixed cycle calculation unit 110 outputs command data in accordance with the command of the surplus redistribution unit 114.

[Step SC07] The surplus redistribution unit 114 determines whether the value of m stored in the memory is 1 (i.e., whether m=1). When m is 1, the processing is advanced to step SC17, and when m is not 1, the processing is advanced to step SC08.

[Step SC08] The surplus redistribution unit 114 commands the fixed cycle calculation unit 110 to output command data for performing a cutting feed operation in which the workpiece is cut by the cutting depth q while rotating the tapping tool T forward. The fixed cycle calculation unit 110 outputs command data in accordance with the command of the surplus redistribution unit 114.

[Step SC09] The surplus redistribution unit 114 commands the fixed cycle calculation unit 110 to output command data for returning the tapping tool T to the return point Pr while rotating the tapping tool T in reverse, whereupon the current processing is terminated. The fixed cycle calculation unit 110 outputs command data in accordance with the command of the surplus redistribution unit 114.

[Step SC10] The surplus redistribution unit 114 adds 1 to the value of n.

[Step SC11] The surplus redistribution unit 114 determines whether n is equal to or larger than m−1 stored in the memory. When n is equal to or larger than m−1 (i.e., when m−1≤n), the processing is advanced to step SC17, and when n is not equal to or larger than m−1, the processing is advanced to step SC12.

[Step SC12] The surplus redistribution unit 114 executes step SC13 to step SC15 repeatedly until n reaches m−1 stored in the memory (i.e., until n=m−1).

[Step SC13] The surplus redistribution unit 114 further adds q to the cutting depth at the time of the previous cutting feed operation and sets the result as the new cutting depth.

[Step SC14] The surplus redistribution unit 114 commands the fixed cycle calculation unit 110 to output command data for performing a cutting feed operation in which the workpiece is cut by the new cutting depth while rotating the tapping tool T forward. The fixed cycle calculation unit 110 outputs command data in accordance with the command of the surplus redistribution unit 114.

[Step SC15] The surplus redistribution unit 114 commands the fixed cycle calculation unit 110 to output command data for returning the tapping tool T to the return point Pr while rotating the tapping tool T in reverse. The fixed cycle calculation unit 110 outputs command data in accordance with the command of the surplus redistribution unit 114.

[Step SC16] A value acquired by adding 1 to n is set as n.

Next, on the flow shown in FIG. 9B, operations are executed in the final iteration n, in which the surplus redistribution unit 114 distributes the surplus.

[Step SC17] The surplus redistribution unit 114 commands the fixed cycle calculation unit 110 to output command data for performing a cutting feed operation in which the workpiece is cut by a cutting depth of q+q′ while rotating the tapping tool T forward, whereupon the processing is advanced to step SC18. The fixed cycle calculation unit 110 starts to output command data in response to the command of the surplus redistribution unit 114.

[Step SC18] The surplus redistribution unit 114 measures the value of the load torque of the spindle motor 62, which is fed back thereto from the spindle amplifier 61.

[Step SC19] The surplus redistribution unit 114 determines whether the load torque value of the spindle motor 62, measured in step SC18, exceeds the preset torque threshold Tt. When the load torque value does not exceed the preset torque threshold Tt, the processing is advanced to step SC20, and when the load torque values exceeds the preset torque threshold Tt, the processing is advanced to step SC21.

[Step SC20] The surplus redistribution unit 114 determines whether the cutting feed operation executed in step SC17 is complete on the basis of the command data output from the fixed cycle calculation unit 110. When the cutting feed operation is complete, the processing is advanced to step SC24, and when the operation is not complete, the processing is returned to step SC18, where measurement of the load torque of the spindle motor 62 is continued.

[Step SC21] The surplus redistribution unit 114 commands the interpolation unit 120 to interrupt the cutting feed operation.

[Step SC22] The surplus redistribution unit 114 commands the fixed cycle calculation unit 110 to output command data for returning the tapping tool T to the return point Pr while rotating the tapping tool T in reverse. The fixed cycle calculation unit 110 outputs command data in accordance with the command of the surplus redistribution unit 114.

[Step SC23] The surplus redistribution unit 114 commands the fixed cycle calculation unit 110 to output command data for performing a cutting feed operation in which the workpiece is cut to the bottom of the hole while rotating the tapping tool T forward, whereupon the processing is advanced to step SC24. The fixed cycle calculation unit 110 outputs command data in accordance with the command of the surplus redistribution unit 114.

[Step SC24] The surplus redistribution unit 114 commands the fixed cycle calculation unit 110 to output command data for returning the tapping tool T to the return point Pr while rotating the tapping tool T in reverse. The fixed cycle calculation unit 110 outputs command data in accordance with the command of the surplus redistribution unit 114.

With the numerical controller having this configuration, the movement distance of the return operation of the tapping tool can be shortened in comparison with a conventional operation without the need for the operator to consciously modify the cutting depth. As a result, the execution time required for the tapping control can be shortened. Furthermore, even when the number of cutting operations remains unchanged after increasing the cutting depth, the overall movement distance decreases, and as a result, the overall execution time required for the tapping can be shortened. Moreover, when possible, the surplus step is redistributed, and therefore the number of cuts performed in the fixed cycle can be reduced in comparison with a conventional operation, enabling a further reduction in the execution time.

Embodiments of the present invention were described above, but the present invention is not limited only to the example embodiments described above and may be implemented in various forms by adding modifications thereto as appropriate.

1. A numerical controller controlling tapping, in which a female screw is formed on an inner surface of a prepared hole formed in a workpiece in accordance with a fixed cycle, on the basis of a processing program,
the numerical controller comprising a fixed cycle calculation unit that analyzes a fixed cycle command included in the processing program and generates a command data sequence including a plurality of command data on the basis of the analysis result,
wherein the fixed cycle calculation unit includes:
a surplus calculation unit that calculates a surplus cutting depth on the basis of an overall cutting depth applied to the workpiece by a tapping tool and a cutting depth applied to the workpiece by the tapping tool in each cut, the respective cutting depths being specified by the fixed cycle command; and
a command data sequence adjustment unit that adjusts the order or the cutting depth of the command data included in the command data sequence on the basis of the surplus cutting depth so as to reduce a total feed movement amount by which the tapping tool moves in accordance with the command data sequence.

2. The numerical controller according to claim 1, wherein the command data sequence adjustment unit further includes an order modification unit that modifies the order of the command data included in the command data sequence so that command data specifying a cutting feed operation of the surplus cutting depth are executed first.

3. The numerical controller according to claim 1, wherein the command data sequence adjustment unit further includes a surplus redistribution unit which, when the surplus cutting depth does not exceed a preset cutting threshold, distributes the surplus cutting depth to command data specifying a cutting feed operation of the cutting depth that is applied to the workpiece by the tapping tool in each cut, the cutting depth being specified by the fixed cycle command.

4. The numerical controller according to claim 1, wherein the command data sequence adjustment unit further includes a surplus redistribution unit that measures a load torque of a spindle motor to which the tapping tool is attached during execution of the final command data of the command data sequence, and adds the surplus cutting depth to the cutting depth of the final command data within a range where the load torque does not exceed a preset torque threshold.
